(19) United States
(12) Patent Application Publication
(10) Pub. No.: US 2008/0268863 A1
(43) Pub. Date: Oct. 30, 2008

(54) Method and Apparatus for Reporting Channel Quality

(76) Inventors: Klaus Pedersen, Aalborg (DK); Troels Kolding, Klarup (DK); Frank Frederiksen, Klarup (DK); Istvan Z. Kovacs, Aalborg (DK)

Correspondence Address: DITTHAVONG MORI & STEINER, P.C., 918 Prince St., Alexandria, VA, 22314, US

(21) Appl. No.: 12/111,584

(22) Filed: Apr. 29, 2008

Related U.S. Application Data
(60) Provisional application No. 60/914,934, filed on Apr. 30, 2007.

(51) Int. Cl. H04Q 7/20; H04B 7/00

(52) U.S. Cl. 455/452.2; 455/509; 455/68; 370/311

(57) ABSTRACT

An approach is provided for efficient signaling for reporting of channel quality information. A parameter is set for a silent period associated with reporting of channel quality information. The channel quality information is transmitted by the terminal only during a time instant outside of the silent period. The silent period is a time interval before transmission of the quality information by the terminal to an inactive state from an active state.

### RELATED APPLICATIONS

This application claims the benefit of the earlier filing date under 35 U.S.C. §119(e) of U.S. Provisional Application Ser. No. 60/914,934 filed Apr. 30, 2007, entitled “Method And Apparatus For Reporting Channel Quality,” the entirety of which is incorporated by reference.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves optimizing transmission of data in a manner that accounts for conservation of system resources—e.g., bandwidth, and power of the terminal. Knowledge of channel quality permits optimization transmission parameters, such as a power requirements, bandwidth allocation, modulation schemes, etc. Traditionally, such channel quality information has been exchanged using signaling mechanisms that waste bandwidth (i.e., by incurring unnecessary overhead).

### SOME EXEMPLARY EMBODIMENTS

Therefore, there is a need for an approach for providing efficient signaling for conveying channel quality information.

According to one embodiment of the invention, a method comprises determining a silent period associated with reporting of channel quality information. The method also comprises transmitting the channel quality information only during a time instant outside of the silent period. The silent period is a time interval before transition to an inactive state from an active state.

According to another embodiment of the invention, an apparatus comprises a logic configured to determine a silent period associated with reporting of channel quality information. The channel quality information is transmitted only during a time instant outside of the silent period. The silent period is a time interval before transition to an inactive state from an active state.

According to another embodiment of the invention, a method comprises setting a parameter for a silent period associated with reporting of channel quality information. The method also comprises signaling the parameter to a terminal. The channel quality information is transmitted by the terminal only during a time instant outside of the silent period. The silent period is a time interval before transition by the terminal to an inactive state from an active state.

According to another embodiment of the invention, an apparatus comprises a logic configured to set a parameter for a silent period associated with reporting of channel quality information. The apparatus further comprises a transceiver that is configured to signal the parameter to a terminal. The channel quality information is transmitted by the terminal only during a time instant outside of the silent period. The silent period is a time interval before transition by the terminal to an inactive state from an active state.

According to another embodiment of the invention, a system comprises means for determining a silent period associated with reporting of channel quality information. The system also comprises means for transmitting the channel quality information only during a time instant outside of the silent period. The silent period is a time interval before transition to an inactive state from an active state.

According to yet another embodiment of the invention, a system comprises means for setting a parameter for a silent period associated with reporting of channel quality information. The system further comprises means for signaling the parameter to a terminal. The channel quality information is transmitted by the terminal only during a time instant outside of the silent period. The silent period is a time interval before transition by the terminal to an inactive state from an active state.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram showing a communication system capable of efficiently conveying channel quality data, according to an exemplary embodiment of the invention;

FIGS. 2A and 2B are diagrams showing, respectively, a traditional channel quality indication reporting pattern, and a channel quality indication reporting pattern utilizing a silent period according with an embodiment of the invention;

FIGS. 3A-3C are processes for conveying channel quality data, in accordance with various exemplary embodiments of the invention;

FIG. 4 is a diagram of hardware that can be used to implement an embodiment of the invention;

FIGS. 5A-5D are diagrams of communication systems having exemplary long-term evolution (LTE) and E-UTRA (Evolved Universal Terrestrial Radio Access) architectures, in which the system of FIG. 1 can operate, according to various exemplary embodiments of the invention; and

FIG. 6 is a diagram of exemplary components of an LTE terminal capable of operating in the systems of FIGS. 5A-5D, according to an embodiment of the invention.

### DESCRIPTION OF PREFERRED EMBODIMENTS

An apparatus, method, and software for providing channel quality indication are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a communication network having a UMTS (Universal Mobile Telecommunication System) Terrestrial Radio Access Network (UTRAN) Long-Term Evolution architecture and channel quality reporting, it is recognized by one of ordinary skill in the art that the embodiments of the inventions have applicability to any type of communication system and equivalent functional capabilities.

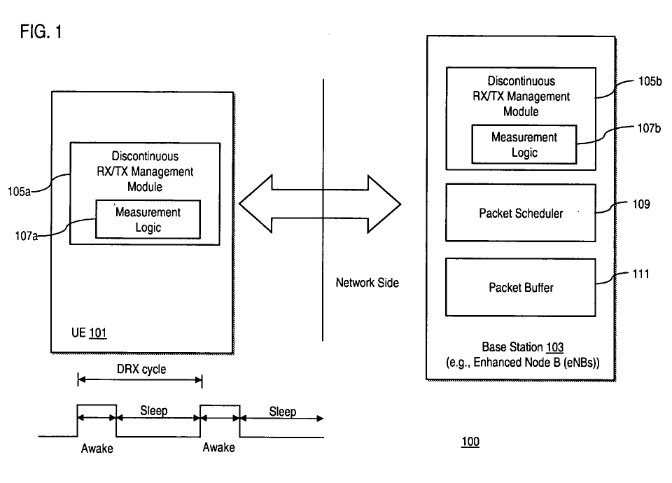

FIG. 1 is a diagram showing a communication system capable of efficiently conveying channel quality data, according to an exemplary embodiment of the invention. For the purposes of illustration, communication system 100 supports the long term evolution (LTE) of the 3GPP FDD (Frequency Division Multiplexing) mode. As shown, a user equipment (UE) 101 communicates with a base station 103, which under the 3GPP LTE architecture is denoted as an enhanced Node B (eNB) 103. The UE 101 can be any type of mobile stations, such as handsets, terminals, stations, units, devices, or any type of interface to the user (such as “wearable” circuitry, etc.).

The UE 101 includes a transceiver (not shown) and an antenna system (not shown) that couples to the transceiver to receive or transmit signals from the base station 103; the antenna system can include one or more antennas. As with the UE 101, the base station 103 employs a transceiver (not shown), which transmits information to the UE 101. Also, the base station 103 can employ one or more antennas for transmitting and receiving electromagnetic signals. For instance, the Node B 103 may utilize a Multiple Input Multiple Output (MIMO) antenna system, whereby the Node B 103 can support multiple antenna transmit and receive capabilities. This arrangement can support the parallel transmission of independent data streams to achieve high data rates between the UEs 101 and Node Bs 103.

As part of the network planning scheme performed at the UE 101 or the enhanced Node B 103, these entities utilize discontinuous reception and/or transmission (RX/TX) management modules 105a, 105b, whereby channel quality information (CQI) reporting is supported. The discontinuous RX/TX management modules 105a, 105b can also include measurement logic 107a, 107b that is configured to determine transmission factors, including radio channel quality and UE speed, etc. For example, the network planning process addresses ACTIVE (or AWAKE) state/IDLE (or SLEEP) state DRX functionality and how to define an efficient and flexible DRX scheme. To facilitate efficient link adaptation and radio channel aware packet scheduling at the base station 103, the UE 101 can transmit channel quality data—e.g., in form of channel indicator quality (CQI) reports—to the base station 103. Under the 3GPP architecture, CQI reports are only sent in the uplink during time-periods in which the terminal 101 is in an AWAKE operational state. That is, these reports are not sent during time-periods where a terminal is in discontinuous reception (DRX) SLEEP mode. To generate the CQI reports, the UE 101 can take measurements of various parameters affecting channel quality—e.g., the power of a pilot channel (also referred to as reference signal). In an exemplary embodiment, it is assumed that the UE measurements are performed when the UE 101 is AWAKE. When UE 101 is not active due to DRX, correspondingly, there is no need to perform CQI measurements by the UE 101.

As shown, the management module 105b of the base station 103 can interact with a packet scheduler 109 to coordinate exchange of data between the UE 101 and the eNB 103; the data to be transmitted to the UE 101 can be stored in a packet buffer 111. This transmission is enhanced using the CQI reports.

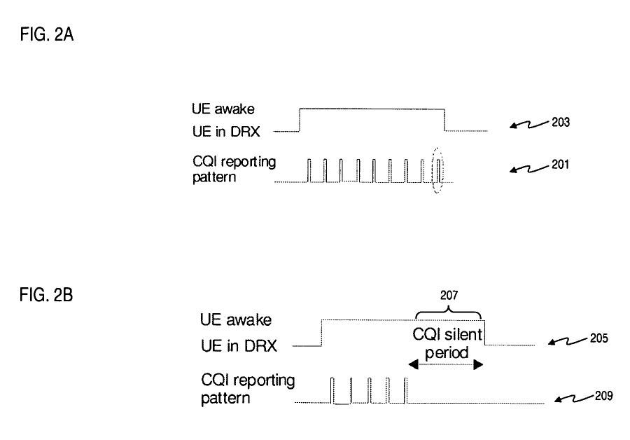

FIGS. 2A and 2B are diagrams showing, respectively, a traditional channel quality indication reporting pattern, and a channel quality indication reporting pattern utilizing a silent period according with an embodiment of the invention. In the traditional scheme of FIG. 2A, a Channel Quality Information (CQI) reports are generated and transmitted to the base station 103, when the UE 101 is in an AWAKE state, as dictated by a CQI reporting pattern 201. As shown, the CQI reporting pattern 201 exists during the AWAKE period of the DRX pattern 203. It is recognized that the one or more CQI reports that are sent by the UE 101 within a short period before the UE 101 enters DRX SLEEP mode (indicated with the dotted ellipse) can result in waste of network resources. Also, a certain amount of time is required for the base station 103 to correctly decode the CQI report from the UE 101; time is also expended when the base station 103 perform new link adaptation and packet scheduling decisions based on the CQI (and to prepare the actual transmission including encoding of a new transport block). Therefore, by the time this process is completed, the UE 101 might be already in DRX SLEEP state, thereby rendering the last CQI useless. The eNode-B 103 lacks sufficient time to prepare a new transmission to the UE 101 (based on the CQI) before the UE 101 enters DRX SLEEP mode. Hence, sending a CQI report (that will not be used) from the UE 101 represents unnecessary overhead in the communication link (e.g., uplink) that provides communication between the UE 101 and the base station 103, and thus wasted network resources.

To address the above recognized problem, an approach (shown in FIG. 2B), according to one embodiment, provides for a scheme to optimize the CQI reporting when it is gated with the DRX pattern 205. In order to avoid the unnecessary transmission of the CQI that could lead to wasting network resources, the approach, in an exemplary embodiment, restricts the last CQI from being sent before the UE 101 enters DRX SLEEP state. It is noted that the UE 101 and the base station 103 are aware of the timing instant where a state transition occurs from when the UE 101 transitions from AWAKE state to SLEEP (or IDLE) state. As seen, a CQI “silent period” 207 is defined immediately before the time that the UE 101 enters the DRX SLEEP state, during which no CQI will be sent to the base station 103 (as evident by the reporting pattern 209). That is, the UE 101 does not transmit any CQI reports during the CQI silent period 207 relative to the time instant where the UE 101 enters DRX SLEEP mode. Thus, no CQIs are sent from the UE 101 during this CQI silent period 207, even though the UE 101 is awake. By way of example, the CQI reporting pattern is periodic during the AWAKE period. However, it is contemplated that other types of CQI reporting patterns 201 can be utilized; e.g., the reporting can be event based during the AWAKE periods.

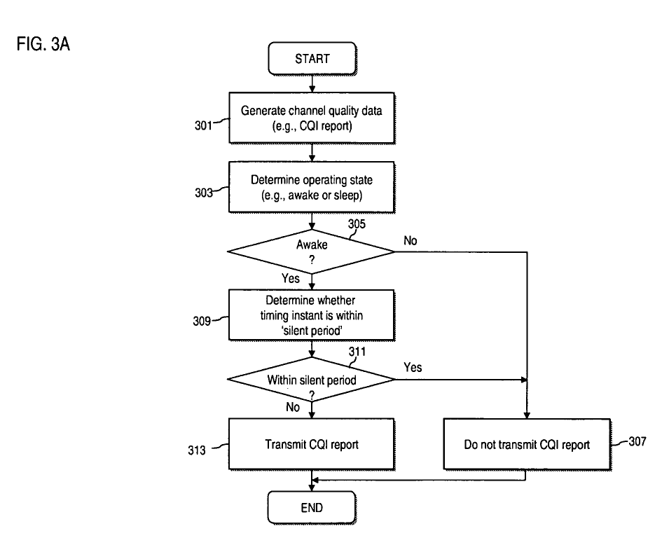

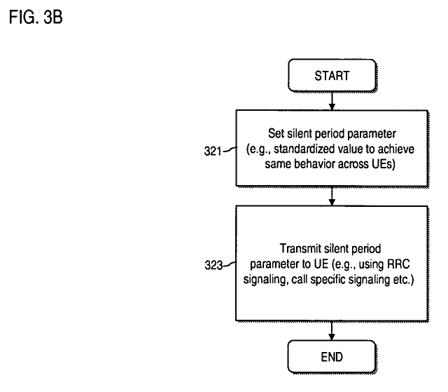

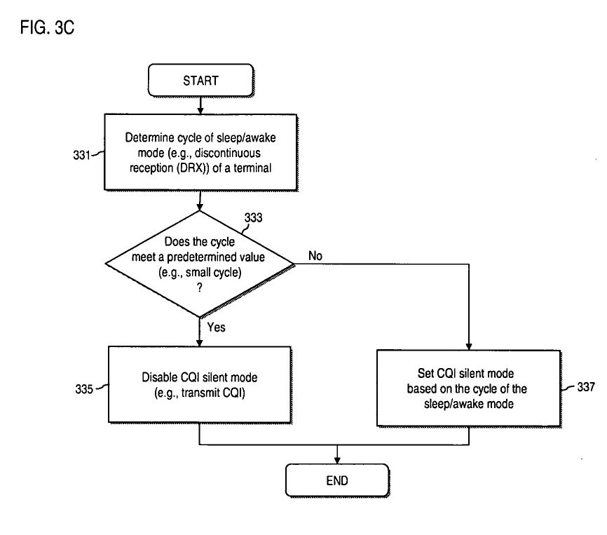

FIGS. 3A-3C are processes for conveying channel quality data, in accordance with various exemplary embodiments of the invention. Specifically, FIG. 3A is a flowchart of process for reporting the Channel Quality Information (CQI), according to an exemplary embodiment. In step 301, channel quality data or information (e.g., CQI report) is generated. Next, the process determines whether the CQI should be transmitted to the base station. In step 303, the operation state of the UE is determined. In step 305, it is checked whether the UE 101 is in an ACTIVE or AWAKE state. If UE 101 is not AWAKE (i.e., in the SLEEP state), the CQI report need not be transmitted to the base station 103, as in step 307.

Otherwise, if the UE 101 is AWAKE, the process determines whether the timing instant is within the silent period (per step 309). This determination, for example, can be implemented using a timer, whereby the start of the silent period triggers the timer, which expires after the silent period. If the silent period has not started (as determined in step 311), the CQI report is transmitted to the base station 103 (step 313). Otherwise, if the timing instant is within the silent period (i.e., timer has not expired), the report will not be transmitted.

In the above process, it is contemplated that the generation of the CQI can be performed at any point before transmission of the CQI report. For instance, the CQI report can be generated only if the report needs to be sent, thereby saving processing resources.

FIG. 3B shows the process of setting a CQI silent period, according to an exemplary embodiment. In step 321, a silent period parameter associated with CQI reporting is set. This parameter, for example, can be predetermined values that are based on standardized values that achieve uniform behavior across UEs 101. In an exemplary embodiment, the duration of the CQI silent period is set by the network (e.g., base station 103) and signaled to the UE 101. According, in step 323, the silent period parameter is transmitted to the UEs 101. The signaling of the CQI silent period can, for instance, be via radio resource control (RRC) signaling, cell specific broadcast signaling, or any other means. By allowing the network to set the duration of the CQI silent period, the processing of received CQIs for link adaptation and packet scheduling can be uniform across different base stations 103, as the base stations 103 are likely to differ from one base station vendor to another.

FIG. 3C shows a process for disabling use of the silent period for reporting CQI, according to an exemplary embodiment. It is recognized that due to the possibility that the value of on-duration (where the UE 101 is in DRX SLEEP mode) can be small, the timer for a UE can be disabled such that a CQI report can be sent anyway. For cases where DRX cycle is sufficiently small, the last value (received at the end of last DRX period) can still be useful for the first scheduling period in the following “UE awake” period. In step 331, the length of a DRX cycle (i.e., a complete AWAKE/SLEEP cycle) is determined. In step 333, the process checks whether the cycle length meets a predetermined value (or threshold value). If the cycle satisfies the value (i.e., the cycle is short enough), the CQI silent mode is disabled (step 335). In an exemplary embodiment, if the DRX cycle is short enough to meet a predetermined value, the last CQI report does not need to be silenced. This is because while this report is being processed by the base station 103, the next UE AWAKE state could start and the process results could be used for this state.

However, if the DRX cycle does not satisfy the predetermined value, the CQI silent mode is set based on the cycle of the sleep/awake mode, as in step 337. That is, the value of the CQI silence period is determined based on the length of the full DRX cycle.

In an exemplary embodiment, the duration of CQI silent period can be fixed to a certain standardized value, so that all UEs behave in the same manner within the network 103, thereby avoiding the need for additional configuration.

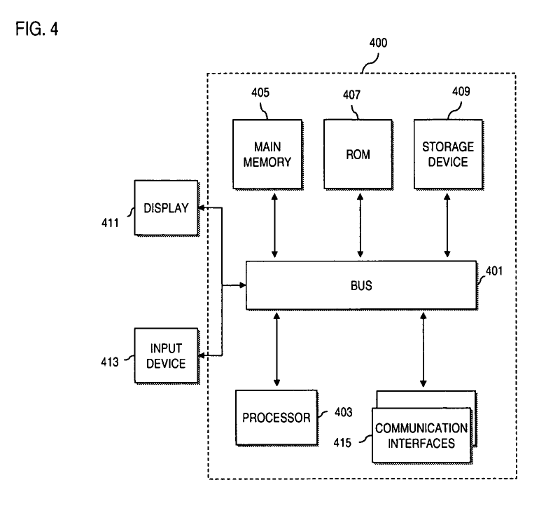

One of ordinary skill in the art would recognize that the processes providing channel quality indication may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 4.

FIG. 4 illustrates exemplary hardware upon which various embodiments of the invention can be implemented. A computing system 400 includes a bus 401 or other communication mechanism for communicating information and a processor 403 coupled to the bus 401 for processing information. The computing system 400 also includes main memory 405, such as a random access memory (RAM) or other dynamic storage device, coupled to the bus 401 for storing information and instructions to be executed by the processor 403. Main memory 405 can also be used for storing temporary variables or other intermediate information during execution of instructions by the processor 403. The computing system 400 may further include a read only memory (ROM) 407 or other static storage device coupled to the bus 501 for storing static information and instructions for the processor 403. A storage device 409, such as a magnetic disk or optical disk, is coupled to the bus 401 for persistently storing information and instructions.

The computing system 400 may be coupled via the bus 401 to a display 411, such as a liquid crystal display, or active matrix display, for displaying information to a user. An input device 413, such as a keyboard including alphanumeric and other keys, may be coupled to the bus 401 for communicating information and command selections to the processor 403. The input device 413 can include a cursor control, such as a mouse, a trackball, or cursor direction keys, for communicating direction information and command selections to the processor 403 and for controlling cursor movement on the display 411.

According to various embodiments of the invention, the processes described herein can be provided by the computing system 400 in response to the processor 403 executing an arrangement of instructions contained in main memory 405. Such instructions can be read into main memory 405 from another computer-readable medium, such as the storage device 409. Execution of the arrangement of instructions contained in main memory 405 causes the processor 403 to perform the process steps described herein. One or more processors in a multi-processing arrangement may also be employed to execute the instructions contained in main memory 405. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 400 also includes at least one communication interface 415 coupled to bus 401. The communication interface 415 provides a two-way data communication coupling to a network link (not shown). The communication interface 415 sends and receives electrical, electromagnetic, or optical signals that carry digital data streams representing various types of information. Further, the communication interface 415 can include peripheral interface devices, such as a Universal Serial Bus (USB) interface, a PCMCIA (Personal Computer Memory Card International Association) interface, etc.

The processor 403 may execute the transmitted code while being received and/or store the code in the storage device 409, or other non-volatile storage for later execution. In this manner, the computing system 400 may obtain application code in the form of a carrier wave.

The term “computer-readable medium” as used herein refers to any medium that participates in providing instructions to the processor 403 for execution. Such a medium may take many forms, including but not limited to non-volatile media, volatile media, and transmission media. Non-volatile media include, for example, optical or magnetic disks, such as the storage device 409. Volatile media include dynamic memory, such as main memory 405. Transmission media include coaxial cables, copper wire and fiber optics, including the wires that comprise the bus 401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

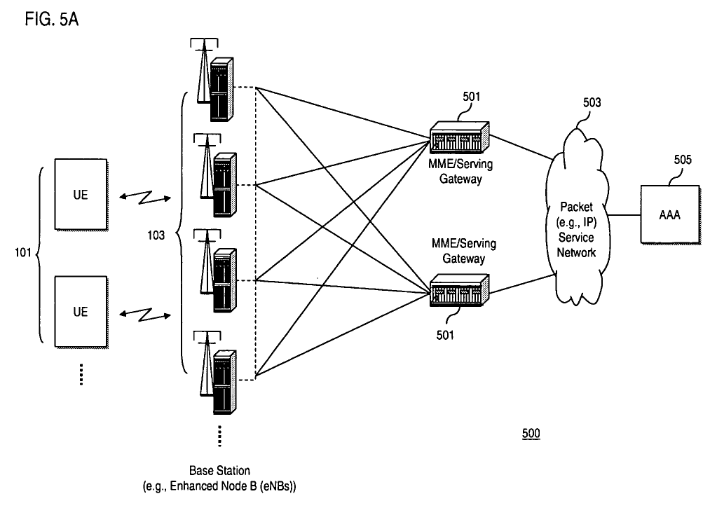

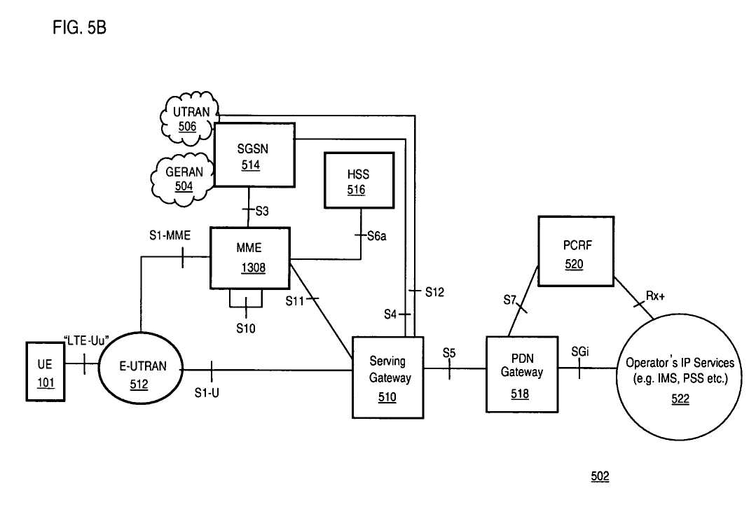

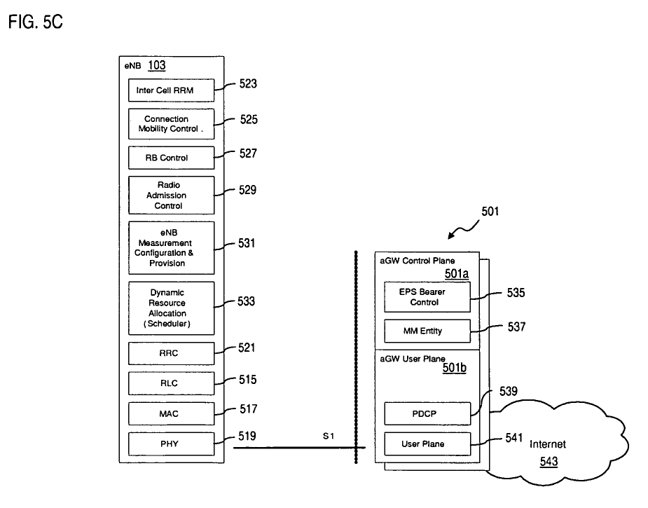

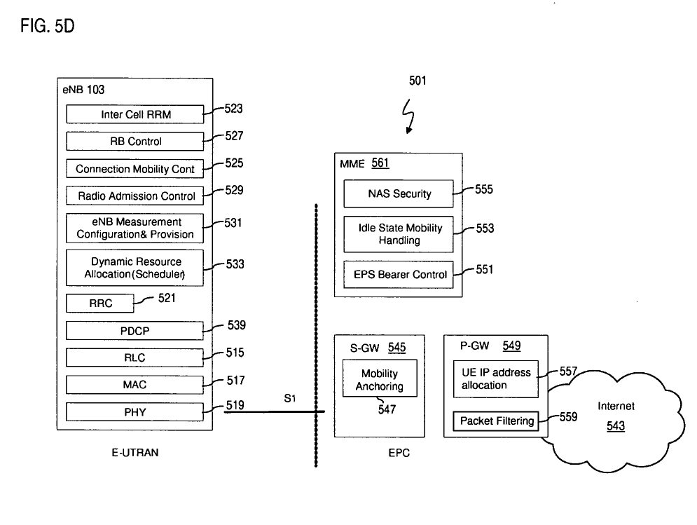

FIGS. 5A-5D are diagrams of communication systems having exemplary long-term evolution (LTE) architectures, in which the system of FIG. 1 can operate, according to various exemplary embodiments of the invention. By way of example (shown in FIG. 5A), a base station (e.g., destination node 103) and a user equipment (UE) (e.g., source node 101) can communicate in system 500 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 500 is compliant with 3GPP LTE, entitled “Long Term Evolution of the 3GPP Radio Technology” (which is incorporated herein by reference in its entirety). As shown in FIG. 5A, one or more user equipment (UEs) 101 communicate with a network equipment, such as a base station 103, which is part of an access network (e.g., WiMAX (Worldwide Interoperability for Microwave Access), 3GPP LTE (or E-UTRAN or 3.9G), etc.). Under the 3GPP LTE architecture, base station 103 is denoted as an enhanced Node B (eNB). The UE 101 can be any type of mobile stations, such as handsets, terminals, stations, units, devices, or any type of interface to the user (such as “wearable” circuitry, etc.).

The MME (Mobile Management Entity)/Serving Gateways 501 are connected to the eNBs 103 in a full or partial mesh configuration using tunneling over a packet transport network (e.g., Internet Protocol (IP) network) 503. Exemplary functions of the MME/Serving GW 501 include distribution of paging messages to the eNBs 103, termination of U-plane packets for paging reasons, and switching of U-plane for support of UE mobility. Since the GWs 501 serve as a gateway to external networks, e.g., the Internet or private networks 503, the GWs 501 include an Access, Authorization and Accounting system (AAA) 505 to securely determine the identity and privileges of a user and to track each user's activities. Namely, the MME Serving Gateway 501 is the key control-node for the LTE access-network and is responsible for idle mode UE tracking and paging procedure including retransmissions. Also, the MME 501 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 5B, a communication system 502 supports GERAN (GSM/EDGE radio access) 504, and UTRAN 506 based access networks, E-UTRAN 512 and non-3GPP (not shown) based access networks, and is more fully described in TR 23.882, which is incorporated herein by reference in its entirety. A key feature of this system is the separation of the network entity that performs control-plane functionality (MME 508) from the network entity that performs bearer-plane functionality (Serving Gateway 510) with a well defined open interface between them 511. Since E-UTRAN 512 provides higher bandwidths to enable new services as well as to improve existing ones, separation of MME 508 from Serving Gateway 510 implies that Serving Gateway 510 can be based on a platform optimized for signaling transactions. This scheme enables selection of more cost-effective platforms for, as well as independent scaling of, each of these two elements. Service providers can also select optimized topological locations of Serving Gateways 510 within the network independent of the locations of MMEs 508 in order to reduce optimized bandwidth latencies and avoid concentrated points of failure.

The basic architecture of the system 502 contains following network elements. As seen in FIG. 5B, the E-UTRAN (e.g., eNB) 512 interfaces with UE 101 via LTE-Uu. The E-UTRAN 512 supports LTE air interface and includes functions for radio resource control (RRC) functionality corresponding to the control plane MME 508. The E-UTRAN 512 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 508, as a key control node, is responsible for managing mobility UE identifies and security parameters and paging procedure including retransmissions. The MME 508 is involved in the bearer activation/deactivation process and is also responsible for choosing Serving Gateway 510 for the UE 101. MME 508 functions include Non Access Stratum (NAS) signaling and related security. MME 508 checks the authorization of the UE 101 to camp on the service provider's Public Land Mobile Network (PLMN) and enforces UE 101 roaming restrictions. The MME 508 also provides the control plane function for mobility between LTE and 2G/3G access networks with the S3 interface terminating at the MME 508 from the SGSN (Serving GPRS Support Node) 514.

The SGSN 514 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 508 and HSS (Home Subscriber Server) 516. The S10 interface between MMEs 508 provides MME relocation and MME 508 to MME 508 information transfer. The Serving Gateway 510 is the node that terminates the interface towards the E-UTRAN 512 via S1-U.

The S1-U interface provides a per bearer user plane tunneling between the E-UTRAN 512 and Serving Gateway 510. It contains support for path switching during handover between eNBs 103. The S4 interface provides the user plane with related control and mobility support between SGSN 514 and the 3GPP Anchor function of Serving Gateway 510.

The S12 is an interface between UTRAN 506 and Serving Gateway 510. Packet Data Network (PDN) Gateway 518 provides connectivity to the UE 101 to external packet data networks by being the point of exit and entry of traffic for the UE 101. The PDN Gateway 518 performs policy enforcement, packet filtering for each user, charging support, lawful interception and packet screening. Another role of the PDN Gateway 518 is to act as the anchor for mobility between 3GPP and non-3GPP technologies such as WiMax and 3GPP2 (CDMA IX and EvDO (Evolution Data Only)).

The S7 interface provides transfer of QoS policy and charging rules from PCRF (Policy and Charging Role Function) 520 to Policy and Charging Enforcement Function (PCEF) in the PDN Gateway 518. The SGi interface is the interface between the PDN Gateway and the operator's IP services including packet data network 522. Packet data network 522 may be an operator external public or private packet data network or an intra operator packet data network, e.g., for provision of IMS (IP Multimedia Subsystem) services. Rx+ is the interface between the PCRF and the packet data network 522.

As seen in FIG. 5C, the eNB 103 utilizes an E-UTRA (Evolved Universal Terrestrial Radio Access) (user plane, e.g., RLC (Radio Link Control) 515, MAC (Media Access Control) 517, and PHY (Physical) 519, as well as a control plane (e.g., RRC 521)). The eNB 103 also includes the following functions: Inter Cell RRM (Radio Resource Management) 523, Connection Mobility Control 525, RB (Radio Bearer) Control 527, Radio Admission Control 529, eNB Measurement Configuration and Provision 531, and Dynamic Resource Allocation (Scheduler) 533.

The eNB 103 communicates with the aGW 501 (Access Gateway) via an S1 interface. The aGW 501 includes a User Plane 501a and a Control plane 501b. The control plane 501b provides the following components: EPS (Evolved Packet System) Bearer Control 535 and MM (Mobile Management) Entity 537. The EPS bearer is further detailed in 3GPP TS 23.401, which is incorporated herein by reference in its entirety. The user plane 501b includes a PDCP (Packet Data Convergence Protocol) 539 and a user plane functions 541. It is noted that the functionality of the aGW 501 can also be provided by a combination of a serving gateway (SGW) and a packet data network (PDN) GW. The aGW 501 can also interface with a packet network, such as the Internet 543.

In an alternative embodiment, as shown in FIG. 5D, the PDCP (Packet Data Convergence Protocol) functionality can reside in the eNB 103 rather than the GW 501. Other than this PDCP capability, the eNB functions of FIG. 5C are also provided in this architecture.

In the system of FIG. 5D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 36.300.

The eNB 103 interfaces via the S1 to the Serving Gateway 545, which includes a Mobility Anchoring function 547. According to this architecture, the MME (Mobility Management Entity) 549 provides EPS (Evolved Packet System) Bearer Control 551, Idle State Mobility Handling 553, and NAS (Non-Access Stratum) Security 555.

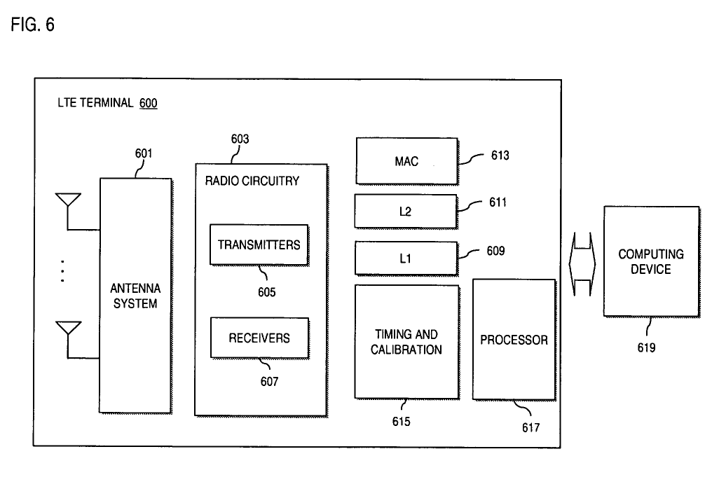

FIG. 6 is a diagram of exemplary components of an LTE terminal capable of operating in the systems of FIGS. 6A-6D, according to an embodiment of the invention. An LTE terminal 600 is configured to operate in a Multiple Input Multiple Output (MIMO) system. Consequently, an antenna system 601 provides for multiple antennas to receive and transmit signals. The antenna system 601 is coupled to radio circuitry 603, which includes multiple transmitters 605 and receivers 607. The radio circuitry encompasses all of the Radio Frequency (RF) circuitry as well as base-band processing circuitry. As shown, layer-1 (L1) and layer-2 (L2) processing are provided by units 609 and 611, respectively. Optionally, layer-3 functions can be provided (not shown). Module 613 executes all MAC layer functions. A timing and calibration module 615 maintains proper timing by interfacing, for example, an external timing reference (not shown). Additionally, a processor 617 is included. Under this scenario, the LTE terminal 600 communicates with a computing device 619, which can be a personal computer, work station, a PDA, web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a silent period associated with reporting of channel quality information; and
transmitting the channel quality information only during a time instant outside of the silent period, wherein the silent period is a time interval before transition to an inactive state from an active state.

2. A method according to claim 1, further comprising:
generating the channel quality information for a communication link to assist with link adaption and packet scheduling at a base station.

3. A method according to claim 2, wherein the channel quality information is a report that includes power level of a reference signal transported over the communication link.

4. A method according to claim 1, further comprising:
receiving a parameter specifying the silent period from a base station.

5. A method according to claim 4, wherein the parameter is signaled according to a cell specific broadcast or a radio resource control signal.

6. A method according to claim 1, wherein the silent period is set to a common duration for a plurality of terminals.

7. A method according to claim 1, further comprising:
disabling use of the silent period to permit transmission of the channel quality information during the active state irrespective of the silent period.

8. A method according to claim 1, wherein the reporting of the channel quality information is according to a periodic pattern.

9. A method according to claim 1, wherein the channel quality information is transmitted over a network compliant with a long term evolution (LTE)-compliant architecture or a Third Generation Partnership Project (3GPP) system.

10. An apparatus comprising:
logic configured to determine a silent period associated with reporting of channel quality information,
wherein the channel quality information is transmitted only during a time instant outside of the silent period, the silent period being a time interval before transition to an inactive state from an active state.

11. An apparatus according to claim 10, wherein the logic is further configured to generate the channel quality information for a communication link to assist with link adaption and packet scheduling at a base station.

12. An apparatus according to claim 11, wherein the channel quality information is a report that includes power level of a reference signal transported over the communication link.

13. An apparatus according to claim 10, further comprising:
a transceiver configured to receive a parameter specifying the silent period from a base station.

14. An apparatus according to claim 13, wherein the parameter is signaled according to a cell specific broadcast or a radio resource control signal.

15. An apparatus according to claim 10, wherein the silent period is set to a common duration for a plurality of terminals.

16. An apparatus according to claim 10, wherein the logic is further configured to disable use of the silent period to permit transmission of the channel quality information during the active state irrespective of the silent period.

17. An apparatus according to claim 10, wherein the reporting of the channel quality information is according to a periodic pattern.

18. An apparatus according to claim 10, wherein the channel quality information is transmitted over a network compliant with a long term evolution (LTE)-compliant architecture or a Third Generation Partnership Project (3GPP) system.

19. A method comprising:
setting a parameter for a silent period associated with reporting of channel quality information; and
signaling the parameter to a terminal, wherein the channel quality information is transmitted by the terminal only during a time instant outside of the silent period, the silent period being a time interval before transition by the terminal to an inactive state from an active state.

20. A method according to claim 19, wherein the terminal is configured to generate the channel quality information for a communication link to assist with link adaption and packet scheduling.

21. A method according to claim 20, wherein the channel quality information is a report that includes power level of a reference signal transported over the communication link.

22. A method according to claim 19, wherein the parameter is signaled according to a cell specific broadcast or a radio resource control signal.

23. A method according to claim 19, wherein the silent period is set to a common duration for a plurality of terminals.

24. A method according to claim 19, wherein the reporting of the channel quality information is according to a periodic pattern.

25. A method according to claim 19, wherein the channel quality information is transmitted over a network compliant with a long term evolution (LTE)-compliant architecture or a Third Generation Partnership Project (3GPP) system.

26. An apparatus comprising:
logic configured to set a parameter for a silent period associated with reporting of channel quality information; and
a transceiver is configured to signal the parameter to a terminal, wherein the channel quality information is transmitted by the terminal only during a time instant outside of the silent period, the silent period being a time interval before transition by the terminal to an inactive state from an active state.

27. An apparatus according to claim 26, wherein the terminal is configured to generate the channel quality information for a communication link to assist with link adaption and packet scheduling.

28. An apparatus according to claim 27, wherein the channel quality information is a report that includes power level of a reference signal transported over the communication link.

29. An apparatus according to claim 26, wherein the parameter is signaled according to a cell specific broadcast or a radio resource control signal.

30. An apparatus according to claim 26, wherein the silent period is set to a common duration for a plurality of terminals.

31. An apparatus according to claim 26, wherein the reporting of the channel quality information is according to a periodic pattern.

32. An apparatus according to claim 26, wherein the channel quality information is transmitted over a network compliant with a long term evolution (LTE)-compliant architecture or a Third Generation Partnership Project (3GPP) system.

33. A system comprising:
means for determining a silent period associated with reporting of channel quality information; and
means for transmitting the channel quality information only during a time instant outside of the silent period, wherein the silent period is a time interval before transition to an inactive state from an active state.

34. A system comprising:
means for setting a parameter for a silent period associated with reporting of channel quality information; and
means for signaling the parameter to a terminal, wherein the channel quality information is transmitted by the terminal only during a time instant outside of the silent period, the silent period being a time interval before transition by the terminal to an inactive state from an active state.
